(19) United States
(12) Patent Application Publication
(10) Pub. No.: US 2026/0328048 A1
(43) Pub. Date: Oct. 22, 2026

(54) MOLDED SKIN DOOR WITH REINFORCED FRAME STRUCTURE

(71) Applicant: James Paschall, Abilene, TX (US)

(72) Inventor: James Paschall, Abilene, TX (US)

(21) Appl. No.: 19/647,145

(22) Filed: Apr. 14, 2026

Related U.S. Application Data
(60) Provisional application No. 63/789,817, filed on Apr. 16, 2025.

(51) Int. Cl. E06B 3/82; E06B 3/70

(52) U.S. Cl. CPC E06B 3/825; E06B 3/7001; E06B 2003/7067

(57) ABSTRACT

In accordance with at least one aspect of this disclosure, a door comprises a frame comprised of two horizonal rail portions and two vertical stile portions. At least one of the vertical stile portions includes a first ply formed of a first material, a second ply formed of a second material that is different from the first material, and a third ply formed of the first material, the three plies forming a layered stack. A stack direction of the layered stack is such that the first ply defines an outer peripheral surface of the frame, the third ply defines an inner peripheral surface of the frame, and the second ply is sandwiched between the first ply and the second ply. The second material is configured to prevent warping of the frame and configured to provide repeated positive engagement for a fastener installed through the frame.

### CROSS REFERENCE TO RELATED APPLICATIONS

This application claims the benefit of priority to U.S. Provisional Patent Application No. 63/789,817, filed Apr. 16, 2025. The entire contents are incorporated herein by reference in their entirety.

### BACKGROUND OF THE INVENTION

### 1. Field of the Invention

The present disclosure relates to door structures, and more particularly to molded skin doors with reinforced frame structure.

### 2. Description of Related Art

Conventional hollow core doors include a rectangular frame made of two horizontal “rails” and two vertical “stiles.” The frame is typically bookended by two door skins or facings. In certain applications, the door skin may be molded, or otherwise formed to include one or more decorative patterns or panels. Conventional stiles and rails used for the door fame are made of wood or a fibrous material, such as medium density fiberboard (“MDF”). However, both conventional materials experience challengers in providing lasting quality. For example, doors utilizing wood stiles and rails can often warp, which is damaging to the aesthetics and function of the door. Those utilizing MDF do not allow for repeated installation or removal of fasteners, for example when removing and reinstalling pre-hung doors during and after painting, or when changing hardware.

The conventional techniques have been considered satisfactory for their intended purpose. However, there is an ever-present need for reinforced door structures that address these challenges. This disclosure provides a solution for this need.

### SUMMARY

In accordance with at least one aspect of this disclosure, a door comprises a frame including two vertically spaced apart horizonal rail portions and two horizontally spaced apart vertical stile portions. At least one of the vertical stile portions includes a first ply formed of a first material, a second ply formed of a second material that is different from the first material, and a third ply formed of the first material. The plies together forming a layered stack, where a stack direction of the layered stack is defined such that the first ply defines an outer peripheral surface of the frame, the third ply defines an inner peripheral surface of the frame, and the second ply is sandwiched between the first ply and the second ply. The second material is configured and adapted to prevent warping of the frame and configured and adapted to provide repeated positive engagement for a fastener installed through the frame.

In certain embodiments, the first material can be or include medium density fiberboard and the second material can be or include laminated veneer lumber. In certain embodiments, the first material can be or include wood and the second material can be or include laminated veneer lumber.

Each of the first ply, the second ply, and the third ply are oriented within at least one of the horizontal rail portions and/or one of the vertical stile portions such that on cross-section, a width of a respective ply is greater than a height of the respective ply.

Each of the horizontal rail portions include a first ply formed of a first material, a second ply formed of a second material that is different from the first material, and a third ply formed of the first material, the three plies together forming a layered stack. A stack direction of the layered stack for each horizontal rail is such that the first ply defines an outer peripheral surface of the frame, the third ply defines an inner peripheral surface of the frame, and the second ply is sandwiched between the first ply and the second ply.

Each of the vertical stile portions include a first ply formed of a first material, a second ply formed of a second material that is different from the first material, and a third ply formed of the first material, the three plies together forming a layered stack. A stack direction of the layered stack for each vertical stile is such that the first ply defines an outer peripheral surface of the frame, the third ply defines an inner peripheral surface of the frame, and the second ply is sandwiched between the first ply and the second ply.

In certain embodiments, a width of the first ply, the second ply, and the third ply extends in a thickness direction of the door such that the first door skin abuts a first side of each of the first ply, the second ply, and the third ply, and the second door skin abuts a second side of each of the first ply, the second ply, and the third ply. In certain embodiments, the vertical stile portions can extend an entire vertical height of the door, and the horizontal rail portions extend between the vertical stile portions.

The door further comprises a core structure included within the frame, the core structure extending vertically between the two horizontal rail portions and extending horizontally between the two vertical stile portions. At least a portion of the core structure is in contact with both of the two horizontal rail portions and both the two vertical stile portions. In certain embodiments, the core structure has a thickness that extends between the first door skin and the second door skin. In certain embodiments, the core structure defines a plurality of polygonal shaped voids, each respective void extending along an axis in a thickness direction between the first door skin and the second door skin. In certain embodiments, there is only one layer of the core structure included within the frame.

In certain embodiments, the core structure can further include a barrier paper included on a first side and second side of the core structure, wherein the first door skin abuts the first barrier paper, and the second door skin abuts the second barrier paper.

In certain embodiments, the door can have at least one recessed surface, where a transition angle from a door facing to the recessed surface is about 45 degrees. In certain embodiments, the door can further include at least one raised surface, wherein the raised surface is below a plane of the door facing and where a transition from the door facing to the raised can have a contoured profile.

In accordance with at least one aspect of this disclosure, a door comprises a frame defining an outer periphery of the door, a first door skin operatively connected to a first side of the frame and a second door skin operatively connected to a second side of the frame opposite the first side, an interior region bound by the fame, and between the first door skin and the second door skin, and a core structure positioned within the interior region, where the core structure is substantially co-extensive with the frame.

The core structure has a thickness that extends between the first door skin and the second door skin, and in certain embodiments, the core structure defines a plurality of polygonal shaped voids, each respective void extending along an axis in a thickness direction between the first door skin and the second door skin. In certain embodiments, only one layer of the core structure is provided within the frame. In certain embodiments, the core structure can further include a barrier paper included on a first side and second side of the core structure, wherein the first door skin abuts the first barrier paper, and the second door skin abuts the second barrier paper.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, other embodiments thereof will be described in detail herein below with reference to certain figures, wherein:

FIGS. 1a to 1e are front elevation views of exemplary embodiments of a plurality of shaker style of hollow core doors in accordance with this disclosure, where:
FIG. 1a shows a single-panel shaker style;
FIG. 1b shows a two-panel shaker style;
FIG. 1c shows a three-panel shaker style;
FIG. 1d shows a three-panel craftsman style;
FIG. 1e shows a five-panel shaker style;

FIG. 2 is a localized cross-sectional profile of the hollow core doors of FIG. 1 taken along the section 2-2, showing of a transition angle of a recessed shaker panel;

FIG. 3 is a front elevation view of an exemplary embodiments of a raised panel style of hollow core door in accordance with this disclosure;

FIG. 4 is a localized cross-sectional profile of the hollow core door of FIG. 3 taken along the section 4-4, showing of a transitional contour of the raised panel;

FIG. 5 is a perspective exploded view of an exemplary embodiment of a hollow core door in accordance with this disclosure, showing the components of the hollow core door;

FIG. 6 is a localized cross-sectional view of an exemplary embodiment of a hollow core door, for example the hollow core door of FIG. 1 taken along the section 6-6, showing internal components of the hollow core door including a rail and a core;

FIGS. 7a and 7b are enlarged localized views of a rail of the hollow core door of FIG. 6, where:
FIG. 7a is a localized cross-sectional view of an exemplary embodiment of a three-ply layered stack of the rail, made of a first material, showing an orientation of the layered stack; and
FIG. 7b is a localized cross-sectional view of an exemplary embodiment of a three-ply layered stack of the rail, made of a second material, showing an orientation of the layered stack; and

FIGS. 8a and 8b are enlarged localized views of a core structure of the hollow core door of FIG. 6, where:
FIG. 8a is perspective view of an exemplary embodiment of a core structure showing removal of a barrier paper for clarity; and
FIG. 8b is a perspective view of exemplary embodiment of a core structure showing movement of the core structure in a direction transverse to a thickness direction of the core structure.

### DETAILED DESCRIPTION OF THE INVENTION

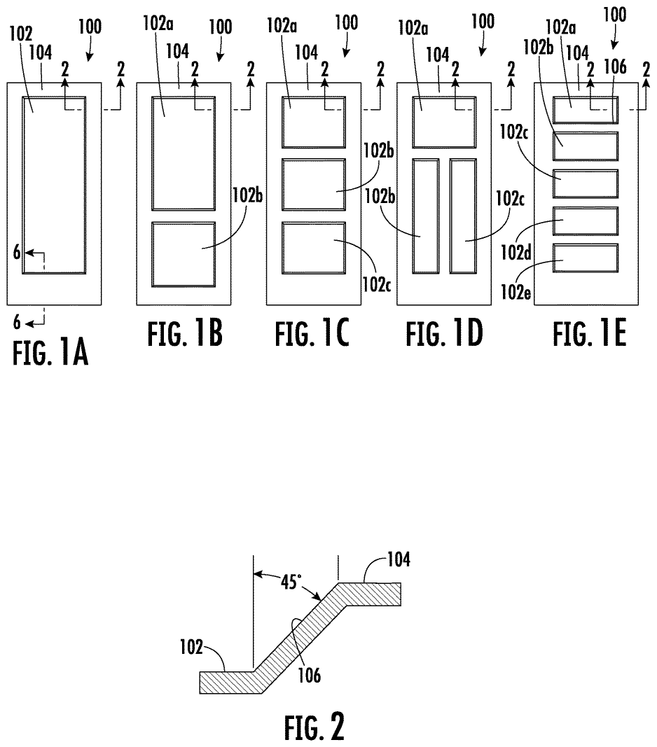

Reference will now be made to the drawings wherein like reference numerals identify similar structural features or aspects of the subject disclosure. For purposes of explanation and illustration, and not limitation, an illustrative view of an embodiment of a door in accordance with the disclosure is shown in FIG. 1 and is designated generally by reference character 100. Other embodiments and/or aspects of this disclosure are shown in FIGS. 2-8b. Certain embodiments described herein can be used to improve the stability and structural integrity of a hollow core door.

FIGS. 1a-1e show various styles of door facings for use on a hollow core door 100. The styles shown in FIGS. 1 a-1e are referred to as shaker style doors. A shaker style door conventionally includes a recessed portion or panel 102 defined in the door facing 104 and a transition portion 106 extending between the door facing 104 and the recessed panel 102. The conventional shaker transition angle is 90° or thereabout. As shown in FIG. 2, the shaker transition angle of each of the doors shown in FIGS. 1a-1e is 135°. Further, a slope of the transition angle, or the ratio of length to height of the transition portion 106, can be 1.0. The difference between the styles shown in FIGS. 1a-1e relate to the number and placement of the recessed portions in the door facing.

For example, FIG. 1a is a single panel shaker style, where only one recessed panel 102 is defined in the door facing 104. The panel 102 can have a height of about 64 inches and a width of about 5 to about 27 inches. The stile width can range from about 3 inches to about 6 inches. FIG. 1b shows a two-panel shaker style, where two recessed panels 102a, 102b are defined in the door facing 104, and in this example, the upper panel 102a is larger than the lower panel 102b. The upper panel 102a can have a height of about 36 inches and a width of about 5 to about 27 inches. The lower panel 102b can have a height of about 21 inches a width of about 5 to about 27 inches. The stile width can range from about 3 inches to about 6 inches. In certain embodiments, the lower panel of the two-panel shaker can be a square. FIG. 1c shows a three-panel shaker design, where three recessed panels 102a, 102b, 102c, are included in the door facing 104. As shown, in this example, the three shaker panels can be equally sized and equally spaced apart from one another. Each of the panels 102a, 102b, 102c can have a height of about 18 inches and a width of about 5 to about 27 inches. The stile width can range from about 3 inches to about 6 inches.

In FIG. 1d, the style shown is known as a three-panel craftsman, where three recessed panels 102a, 102b, 102c, are shown, where the upper panel 102a is rectangular in the horizontal direction, while the lower panels 102b, 102c, are rectangular in the vertical direction. The upper panel 102a can have a height of about 16 inches and a width of about 5 to about 27 inches. The lower panels 102b, 102c can have a height of about 43 inches a width of about 5 to about 12 inches. The stile width can range from about 3 inches to about 5 inches. FIG. 1e shows a five-panel shaker design, where five recessed panels 102a, 102b, 102c, 102d, 102e are included in the door facing 104. As shown, in this example, the five shaker panels can be equally sized and equally spaced apart from one another. Each of the panels 102a, 102b, 102c, 102d, 102e can have a height of about 10 inches and a width of about 9 to about 26 inches. The stile width can range from about 3 inches to about 5 inches.

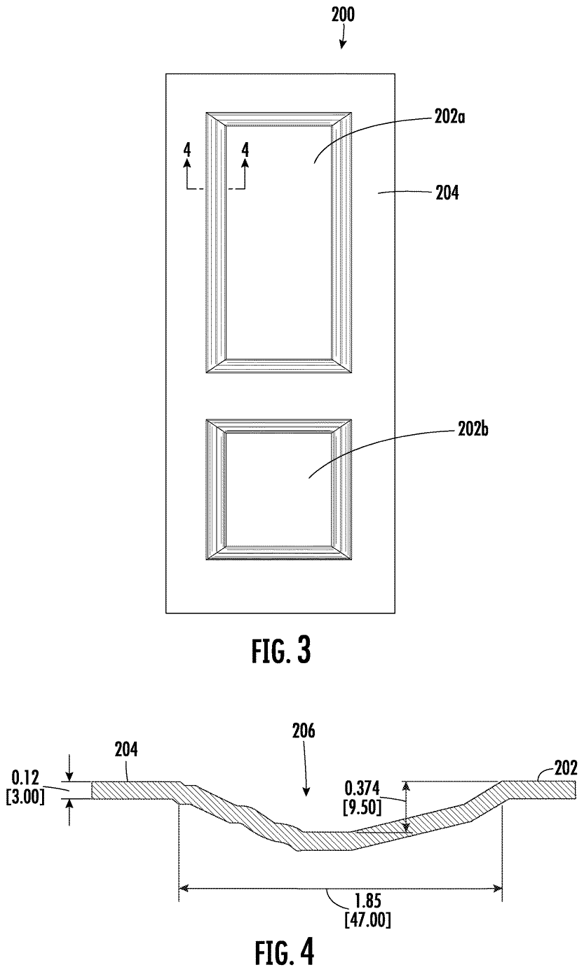

Referring now to FIGS. 3 and 4, FIG. 3 shows an example of another style of door, known as a raised panel door. The door 200 has a raised panel or portion 202 defined in the door facing 204. An exemplary embodiment of the profile of the transition 206 from the door facing 204 to the raised panel 202 is shown in FIG. 4. Though the door style is referred to as a raised panel, the raised panel 202 is still defined in a plane below a plane of the door facing 204 as is seen in FIG. 4. As shown in FIG. 4, the transition portion 206 can have a series of intermediate transitions for decorative purposes. Though FIG. 3 shows an example of a two-panel raised style, having an upper raised panel 202a and a lower raised panel 202b, any one or more of the styles shown in FIGS. 1a-1e could utilize the raised panel style as well. The upper panel 202a can have a height of about 36 inches and a width of about 5 to about 24 inches. The lower panel 102b can have a height of about 23 inches a width of about 5 to about 24 inches. The stile width can range from about 3 inches to about 6 inches. In certain embodiments, the lower panel 202 b can form a square.

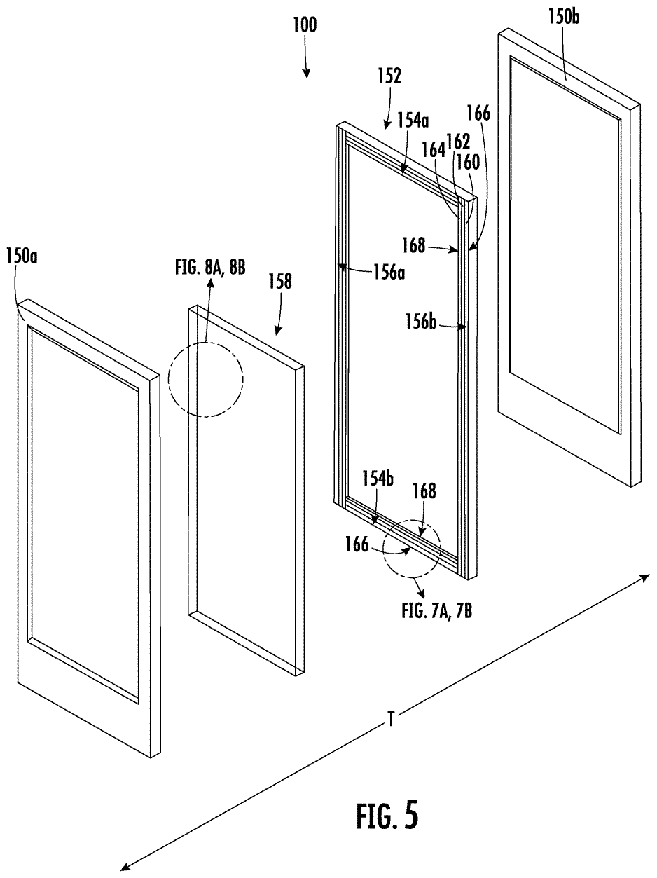

Turning now to FIGS. 5 through 8b, the structure of the door will be discussed. While FIGS. 5 to 8b refer to localized views of FIG. 1, the structure of the door shown and described with respect to FIGS. 5-8b can be utilized in any of the exemplary door styles shown in FIGS. 1a to 1e or FIG. 3.

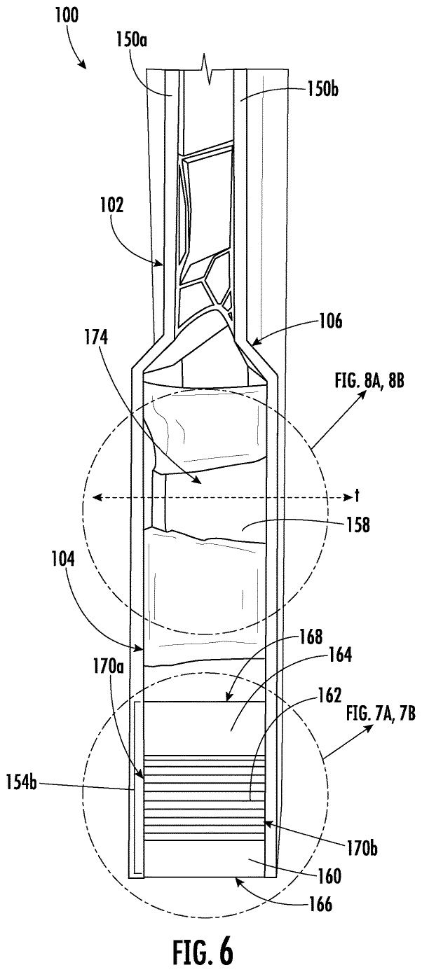

FIG. 5 shows an exploded perspective view of an exemplary embodiment of a door 100. The door 100 includes a first door skin 150a and a second door skin 150b. The door 100 also includes a frame 152. The frame includes two vertically spaced apart horizontal rails 154a, 154b, and two horizontally spaced vertical stiles 156a, 156b. The door 100 can include within the frame, a core structure 158. In FIG. 6 a localized cross-sectional view of the assembled door 100 is shown, the cross section taken along the line 6-6 shown in FIG. 1a. FIG. 6 shows the lower horizontal rail 154b, the core structure 158 extending between the first and second door skins 150a and 150b, and further illustrates the profile of the transition portion 106 from the facing 104 to the recessed panel 102.

As shown in FIG. 6, and as seen more clearly in FIGS. 7a and 7b, the lower horizontal rail 154b can include three plies. A first ply 160 formed of a first material, a second ply 162 formed of a second material different from the first material, and a third ply 164 formed of the first material, where the three plies together form a layered stack. As shown in FIG. 6, the layered stack is oriented such that the first ply 160 defines an outer peripheral surface 166 of the frame, the third ply 164 defines an inner peripheral surface 168 of the frame 152, and the second ply 162 is sandwiched between the first ply 160 and the second ply 164.

The second material can be a material configured to prevent warping of the frame 152 and configured to provide greater holding power for a fastener installed through the frame 152. For example, the material of the second ply 162 can be laminated veneer lumber, or LVL. Each of the first ply 160, the second ply 162, and the third ply 164 are oriented such that on cross-section, a width W of the respective ply 160, 162, 164 is greater than a height H of the respective ply 160, 162, 164. Because of this orientation, the LVL ply will not be able to bend or warp out of plane. Further, any fastener inserted through the frame 152 on either of on the rail portions 154a, 154b, or the stile portions 156a 156b, will extend through the first ply 160 and into the second ply 162. The LVL of the second ply 162 is much harder than conventional materials used for door frame, and therefore allows for repeated installation or removal of fasteners from the frame 152. This can be critical when working with pre-hung doors, for example, which often require painters to remove the hinges from the door before painting, then reinstall the hinges once the painting is complete.

In certain embodiments, such as illustrated in FIG. 7a, the first material, i.e. the material used for the first ply 760 and the third ply 764 can be MDF. As shown, the MDF sandwiches the second ply 762, which is LVL. The two MDF plies 760 and 764 define the outer 766 and inner 768 peripheral surfaces of the frame. Alternatively, such as illustrated in FIG. 7b, in certain embodiments, the first material is wood, where the first ply 860 and third ply 864 are made of wood. The two wood plies 860 and 864 define the outer 866 and inner 868 peripheral surfaces of the frame and sandwich the second ply 862, the LVL, therebetween.

Though the three ply layered stack configuration is shown with respect to the lower horizontal rail 154b, any one or more of the horizontal rails 154a, 154b, or vertical stiles 156a, 156b, can include the three ply layered stack. In certain embodiments, such as shown more clearly in FIG. 5, all of the rails 154a, 154b, and stiles 156a, 156b can utilize the three ply layered stack configuration. In such embodiments, the stack direction is always oriented where the width W of the first ply 160, the second ply 162, and the third ply 164 extends in a thickness direction T of the door 100, such that the first door skin 150a abuts a first side 170a of each of the first ply 160, the second ply 162, and the third ply 164, and the second door skin 150b abuts a second side 170b of each of the first ply 160, the second ply 162, and the third ply 164.

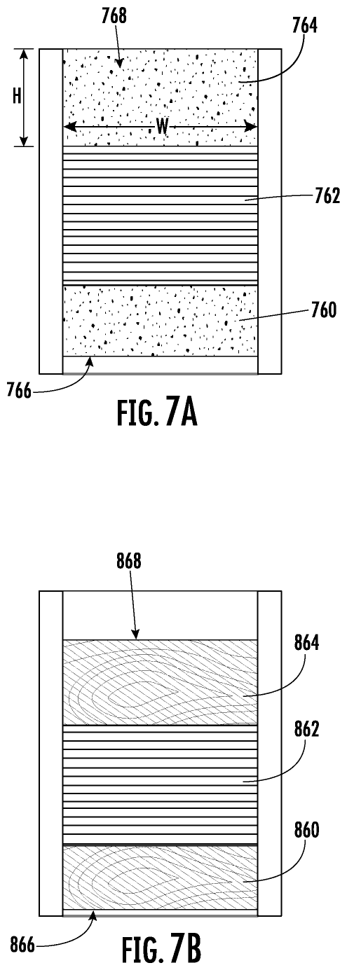

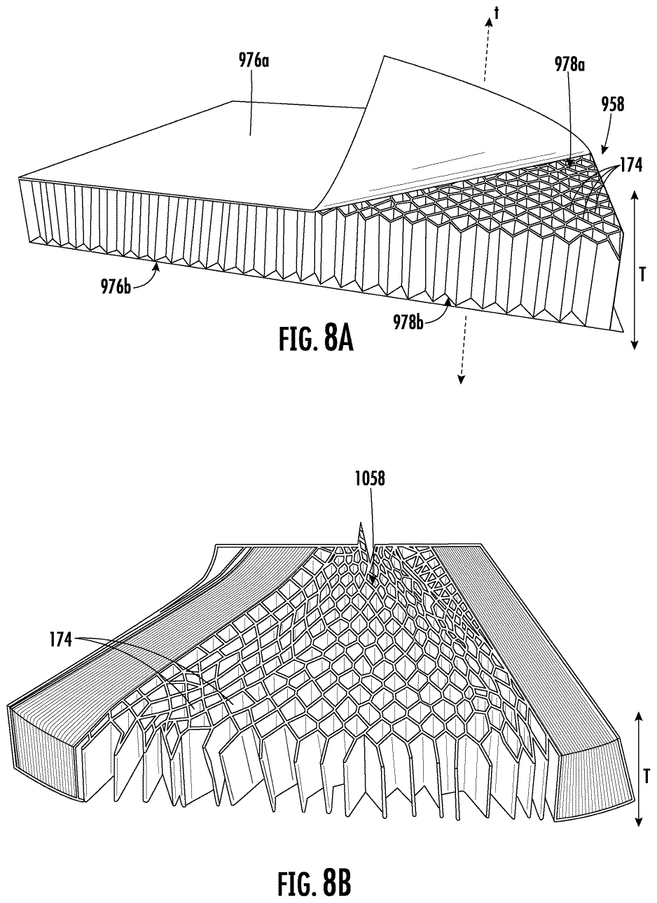

With reference now to FIGS. 6, 8a, and 8b, the core structure 158 will be described. As shown, the core structure 158 is included within the frame 152 and extends vertically between the two horizontal rail portions 154a, 154b, and extends horizontally between the two vertical stile portions 156a, 156b. As such, the core structure 158 is co-extensive with the frame, and at least partially in contact with each of the two horizontal rail portions 154a, 154b and the two vertical stile portions156a, 156b. In certain embodiments, the core structure 158 is in contact with the inner peripheral surface 168 of the frame 152 as defined by the third ply 164 of the rail 154a, 154b or stile 156a, 156b.

As shown in FIG. 6, the core structure 158 has a thickness that extends between the first door skin 150a and the second door skin 150b, in the thickness direction T of the door 100. As seen more clearly in the enlarged localized views of FIGS. 8a and 8b, the core structure 158 defines a plurality of polygonal shaped voids 174, each respective void extending along an axis t colinear with the thickness direction T of the door 100, defined between the first door skin 150a, 150b and the second door skin. In certain embodiments, the polygonal shaped voids 174 can be quadrilateral, pentagonal, hexagonal, or any suitable combination thereof. In certain embodiments, the core structure can be or include a “honeycomb” shaped structure.

As shown in FIG. 8a, in certain embodiments, the core structure 958 can further include a barrier paper 976a, 976b included on a first side 978a and second side 978b of the core structure 958. In such embodiments, the first door skin 150a would abut the first barrier paper 976a, and the second door skin 150b would abut the second barrier paper 976b. With reference to FIG. 8b, in certain embodiments the core structure 1058 does not include any barrier papers. Therefore, the core 1058 is free to extend or contract in an accordion like fashion in a direction transverse to the thickness direction T, so as to be substantially coextensive with the frame 152. FIG. 8b shows the core structure 1058 partially extended in the middle section, and folded in the terminal sections. Embodiments of the core structure 158, 958, 1058 further improve the strength of the door, and structural integrity to prevent against warping, without significantly increasing the weight of the door 100.

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. A door, comprising:
a frame including two vertically spaced apart horizonal rail portions and two horizontally spaced apart vertical stile portions, wherein at least one of the vertical stile portions includes:
a first ply formed of a first material, a second ply formed of a second material that is different from the first material, and a third ply formed of the first material, the plies together forming a layered stack, wherein a stack direction of the layered stack is such that the first ply defines an outer peripheral surface of the frame, the third ply defines an inner peripheral surface of the frame, and the second ply is sandwiched between the first ply and the second ply,
whereby the second material is configured to prevent warping of the frame and configured to provide repeated positive engagement for a fastener installed through the frame.

2. The door of claim 1, wherein the first material is medium density fiberboard, and wherein the second material is laminated veneer lumber.

3. The door of claim 1, wherein the first material is wood, and wherein the second material is laminated veneer lumber.

4. The door of claim 1, wherein each of the first ply, the second ply, and the third ply are oriented within at least one of the horizontal rail portions and/or one of the vertical stile portions such that on cross-section, a width of a respective ply is greater than a height of the respective ply.

5. The door of claim 1, wherein each of the horizontal rail portions include a first ply formed of a first material, a second ply formed of a second material that is different from the first material, and a third ply formed of the first material, the three plies together forming a layered stack, wherein a stack direction of the layered stack is such that the first ply defines an outer peripheral surface of the frame, the third ply defines an inner peripheral surface of the frame, and the second ply is sandwiched between the first ply and the second ply.

6. The door of claim 1, wherein each of the vertical stile portions include a first ply formed of a first material, a second ply formed of a second material that is different from the first material, and a third ply formed of the first material, the three plies together forming a layered stack, wherein a stack direction of the layered stack is such that the first ply defines an outer peripheral surface of the frame, the third ply defines an inner peripheral surface of the frame, and the second ply is sandwiched between the first ply and the second ply.

7. The door of claim 1, wherein a width of the first ply, the second ply, and the third ply extends in a thickness direction of the door such that the first door skin abuts a first side of each of the first ply, the second ply, and the third ply, and the second door skin abuts a second side of each of the first ply, the second ply, and the third ply.

8. The door of claim 1, wherein the vertical stile portions extend an entire vertical height of the door, and wherein the horizontal rail portions extend between the vertical stile portions.

9. The door of claim 1, further comprising, a core structure included within the frame, the core structure extending vertically between the two horizontal rail portions and extending horizontally between the two vertical stile portions.

10. The door of claim 9, wherein at least a portion of the core structure is in contact with both of the two horizontal rail portions and both the two vertical stile portions.

11. The door of claim 9, wherein the core structure has a thickness that extends between the first door skin and the second door skin.

12. The door of claim 11, wherein the core structure defines a plurality of polygonal shaped voids, each respective void extending along an axis in a thickness direction between the first door skin and the second door skin.

13. The door of claim 9, wherein only one layer of the core structure is included within the frame.

14. The door of claim 9, wherein the core structure further includes a barrier paper included on a first side and second side of the core structure, wherein the first door skin abuts the first barrier paper, and the second door skin abuts the second barrier paper.

15. The door of claim 1, wherein the door has at least one recessed surface, wherein a transition angle from a door facing to the recessed surface is about 45 degrees.

16. The door of claim 1, wherein the door has at least one raised surface, wherein the raised surface is below a plane of a door facing, wherein a transition from the door facing to the raised has contoured profile.

17. A door, comprising:
a frame defining an outer periphery of the door,
a first door skin operatively connected to a first side of the frame and a second door skin operatively connected to a second side of the frame opposite the first side;
an interior region bound by the fame, and between the first door skin and the second door skin; and
a core structure positioned within the interior region, where the core structure is substantially co-extensive with the frame.

18. The door of claim 17, wherein the core structure has a thickness that extends between the first door skin and the second door skin.

19. The door of claim 18, wherein the core structure defines a plurality of polygonal shaped voids, each respective void extending along an axis in a thickness direction between the first door skin and the second door skin.

20. The door of claim 17, wherein the core structure further includes a barrier paper included on a first side and second side of the core structure, wherein the first door skin abuts the first barrier paper, and the second door skin abuts the second barrier paper.
